(19) United States
(12) Patent Application Publication
(10) Pub. No.: US 2013/0065189 A1
(43) Pub. Date: Mar. 14, 2013

(54) THERMAL TREATMENT APPARATUS, TEMPERATURE CONTROL SYSTEM, THERMAL TREATMENT METHOD, TEMPERATURE CONTROL METHOD, AND NON-TRANSITORY COMPUTER READABLE MEDIUM EMBODIED WITH PROGRAM FOR EXECUTING THE THERMAL TREATMENT METHOD OR THE TEMPERATURE CONTROL METHOD

(71) Applicants: Koji Yoshii, Oshu-shi (JP); Tatsuya Yamaguchi, Sapporo City (JP); Wenling Wang, Oshu-shi (JP); Takanori Saito, Oshu-shi (JP)

(72) Inventors: Koji Yoshii, Oshu-shi (JP); Tatsuya Yamaguchi, Sapporo City (JP); Wenling Wang, Oshu-shi (JP); Takanori Saito, Oshu-shi (JP)

(73) Assignee: TOKYO ELECTRON LIMITED, Tokyo (JP)

(21) Appl. No.: 13/611,317

(22) Filed: Sep. 12, 2012

(30) Foreign Application Priority Data
Sep. 13, 2011 (JP) 2011-199621

(51) Int. Cl. F27D 15/02; F27D 3/00; F27D 21/00

(52) U.S. Cl. 432/9; 432/77; 432/32

(57) ABSTRACT

A thermal treatment apparatus includes a processing container, a substrate holding unit for holding a plurality of substrates at predetermined intervals in a direction inside the processing container, a heating unit for heating the processing container, a supply unit for supplying gas, a plurality of supply ports provided respectively at different locations in the direction, and a cooling unit for cooling the processing container by supplying the gas into the processing container by the supply unit via each of the supply ports, wherein the supply unit is provided in such a way that the supply unit independently controls flow rates of the gases supplied via each of the supply ports.

### CROSS-REFERENCE TO RELATED PATENT APPLICATIONS

This application claims the benefit of Japanese Patent Application No. 2011-199621, filed on Sep. 13, 2011 in the Japan Patent Office, the disclosure of which is incorporated herein in its entirety by reference.

### BACKGROUND OF THE INVENTION

1. Field of the Invention

The present invention relates to a thermal treatment apparatus, a temperature control system, a thermal treatment method, a temperature control method, and a non-transitory computer readable medium embodied with a program for executing the thermal treatment method or the temperature control method.

2. Description of the Related Art

In manufacture of a semiconductor device, various processing apparatuses are used to perform processes such as oxidation, dispersion, chemical vapor deposition (CVD), etc. on a substrate, for example, a semiconductor wafer. A vertical thermal treatment apparatus capable of simultaneously performing a thermal treatment on a plurality of substrates to be processed is well known as one of the processing apparatuses.

A thermal treatment apparatus includes a processing container, a boat, an elevation mechanism, and a transfer mechanism. The boat is a substrate holding unit that holds a plurality of substrates in a vertical direction at predetermined intervals to carry the substrates into/out of the processing container. The elevation mechanism is provided in a loading area disposed below the processing container. The elevation mechanism elevates a cover unit when the boat is mounted on the cover unit for covering an opening of the processing container to elevate the boat between the processing container and the loading area. The transfer mechanism transfers the substrates between the boat moved to the loading area and an accommodating container for accommodating the plurality of substrates.

Also, there is another thermal treatment apparatus that includes a heater for heating a substrate held by a boat in a processing container and a jacket for covering the processing container. The heater is provided inside the jacket around the processing container and a space where a cooling gas for cooling the processing container is supplied is defined inside the jacket around the processing container. When the substrate held by the boat inside the processing container is thermally heated by, for example, the heater and then is cooled, the cooling gas is supplied into the space to control a cooling speed of the substrate (refer to Patent Reference 1).

However, in the thermal treatment apparatus, when the substrate is thermally heated and then is cooled, the cooling speed may vary in a vertical direction.

For example, in Patent Reference 1, the cooling gas is supplied into the space between the processing container and the jacket from a feed opening provided at a bottom portion of the jacket. The cooling gas flows upward from below in the space and is discharged via an outlet provided at an upper portion of the jacket. Accordingly, the cooling speed of the processing container varies in a vertical direction, and a history of the thermal treatment varies between the substrates held by the boat at predetermined intervals in a vertical direction, and thus, the quality of the substrates after the thermal treatment may vary.

When the cooling speed of the processing container varies, a plurality of heaters may be provided at different locations in the vertical direction, and an amount of heat generated by the heaters may be independently controlled in such a way that the cooling speed of the processing container may be equal in a vertical direction. However, since the heaters are controlled in such a way that an amount of heat generated by the heaters provided in a portion having a relatively higher cooling speed is greater than an amount of heat generated by the heaters provided in another portion, power consumption during the cooling process increases.

Also, the above-described problem is not limited to a case where the substrates are held in a vertical direction and may occur even when the substrates are held at predetermined intervals in a certain direction. In addition, the above-described problem is not limited to a case of cooling a thermal treatment container for thermally processing the substrates and may occur even when a container extending in a certain direction is cooled.

### PRIOR ART REFERENCE

(Patent Reference 1) Japanese Laid-Open Patent Publication No. 2009-81415

### SUMMARY OF THE INVENTION

The present invention provides a thermal treatment apparatus, a temperature control system, a thermal treatment method, and a temperature control method that are used to prevent generation of a difference in a cooling speed of a container when cooling the container extending in a certain direction without increasing power consumption.

To solve the above-described problem, each of devices in the below description is considered in the present invention.

According to an aspect of the present invention, a thermal treatment apparatus for performing a thermal treatment on a substrate, the thermal treatment apparatus includes a processing container; a substrate holding unit which holds a plurality of substrates at predetermined intervals in a direction inside the processing container; a heating unit which heats the processing container; and a cooling unit which includes a supply unit for supplying gas and a plurality of supply ports provided respectively at different locations in the direction, and cools the processing container as the supply unit supplies the gas into the processing container via each of the supply ports, wherein the cooling unit is provided in such a way that the supply unit independently controls flow rates of the gases supplied via each of the supply ports.

According to another aspect of the present invention, a temperature control system for controlling a temperature of a container extending in a direction, the temperature control system includes a heating unit which heats the container; and a cooling unit which includes a supply unit for supplying gas and a plurality of supply ports provided at different locations in the direction, and cools the container as the supply unit supplies the gas into the container via each of the supply ports; a detecting unit which includes a plurality of detection devices provided at different locations in the direction and detects a temperature distribution in the direction inside the container; and a control unit which independently controls flow rates of gases supplied by the supply unit via each of the supply ports so as to equalize the cooling speed of the container in the direction based on values detected by the detecting unit, when cooling the container.

According to another aspect of the present invention, a thermal treatment method used to perform a thermal treatment on a substrate, the method includes when a plurality of substrates are held by a substrate holding unit at predetermined intervals in a direction inside a processing container, performing a thermal treatment on the plurality of substrates held by the substrate holding unit by heating the processing container by a heating unit; and after the performing of the thermal treatment, cooling the processing container by supplying gas into the processing container by a supply unit via each of a plurality of supply ports provided at different locations in the direction; wherein the cooling of the processing container includes independently controlling flow rates of gases supplied by the supply unit via each of the supply ports so as to equalize a cooling speed of the processing container in the direction.

According to another aspect of the present invention, a temperature control method used to control a temperature of a container extending in a direction, the method includes heating the container by a heating unit; and cooling the container by supplying gas into the container by a supply unit via each of a plurality of supply ports provided at different locations in the direction; wherein the cooling of the container includes independently controlling flow rates of gases supplied by the supply unit via each of the supply ports so as to equalize a cooling speed of the container in the direction.

Additional objects and advantages of the invention will be set forth in the description which follows, and in part will be obvious from the description, or may be learned by practice of the invention.

The objects and advantages of the invention may be realized and obtained by means of the instrumentalities and combinations particularly pointed out hereinafter.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a vertical cross-sectional view schematically showing a thermal treatment apparatus, according to an embodiment of the present invention;

FIG. 2 is a perspective view schematically showing a loading area;

FIG. 3 is a perspective view schematically showing an example of a boat;

FIG. 4 is a cross-sectional view schematically showing a constitution of a thermal treatment furnace;

FIG. 5 is a flowchart for describing a sequence of each process of a thermal treatment method using a thermal treatment apparatus, according to an embodiment of the present invention;

FIG. 6 is a graph showing a relationship between temperature and time in each unit area, according to an embodiment of the present invention;

FIG. 7 is a graph showing a relationship between temperature and time in each unit area, according to a comparative example of the present invention;

FIG. 8 is a graph showing a relationship between temperature and time in each unit area, according to another comparative example of the present invention;

FIG. 9 is a graph showing a relationship between time and a difference between a detected highest temperature and a detected lowest temperature from among temperatures detected by a temperature sensor inside a processing container when an inflow suppressing member is provided, according to an embodiment of the present invention;

FIG. 10 is a graph showing a relationship between time and a difference between a detected highest temperature and a detected lowest temperature from among temperatures detected by a temperature sensor inside a processing container when an inflow suppressing member is not provided, according to an embodiment of the present invention;

FIG. 11 is a graph showing a relationship between a temperature detected by a temperature sensor inside a processing container and time when a first mode is performed;

FIG. 12 is a graph showing a relationship between outputs of a blower and a heater and time when the first mode is performed;

FIG. 13 is a graph showing a relationship between a temperature detected by a temperature sensor inside a processing container and time when a second mode is performed; and

FIG. 14 is a graph showing a relationship between outputs of a blower and a heater and time when the second mode is performed.

### DETAILED DESCRIPTION OF THE INVENTION

An embodiment of the present invention achieved on the basis of the findings given above will now be described with reference to the accompanying drawings. In the following description, the constituent elements having substantially the same function and arrangement are denoted by the same reference numerals, and a repetitive description will be made only when necessary.

Hereinafter, the present invention will be described in detail by explaining exemplary embodiments of the invention with reference to the attached drawings.

First, a thermal treatment apparatus according to an embodiment of the present invention will be described. The thermal treatment apparatus 10 includes a vertical thermal treatment furnace 60 to be described below, and a plurality of wafers W are held by a boat at predetermined intervals in a vertical direction. The thermal treatment apparatus 10 may simultaneously accommodate the plurality of wafers W, and various thermal treatments, such as oxidation, dispersion, or depressurized chemical vapor deposition, may be performed on the wafers W accommodated in the thermal treatment apparatus 10. Hereinafter, a thermal treatment apparatus supplying a processing gas consisting of, for example, water vapor to a substrate provided inside a processing container 65, to be described below, to perform an oxidation process on a surface of the substrate is described.

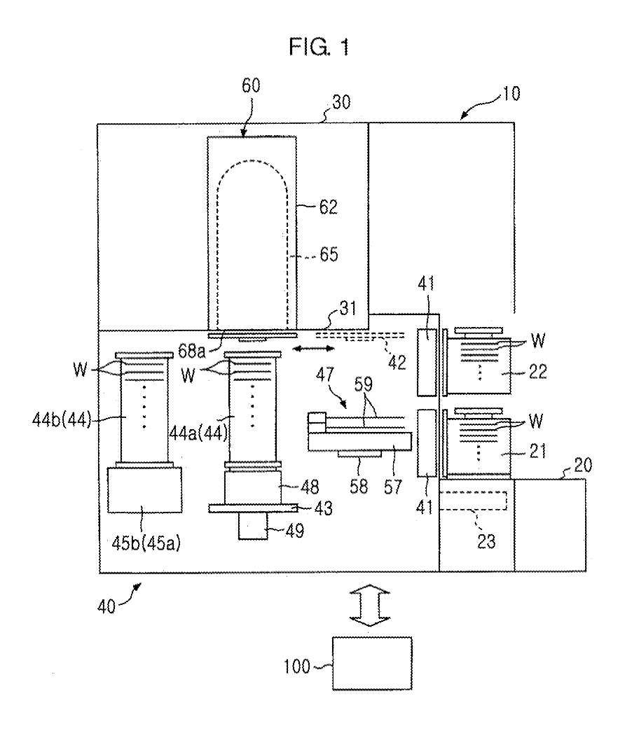

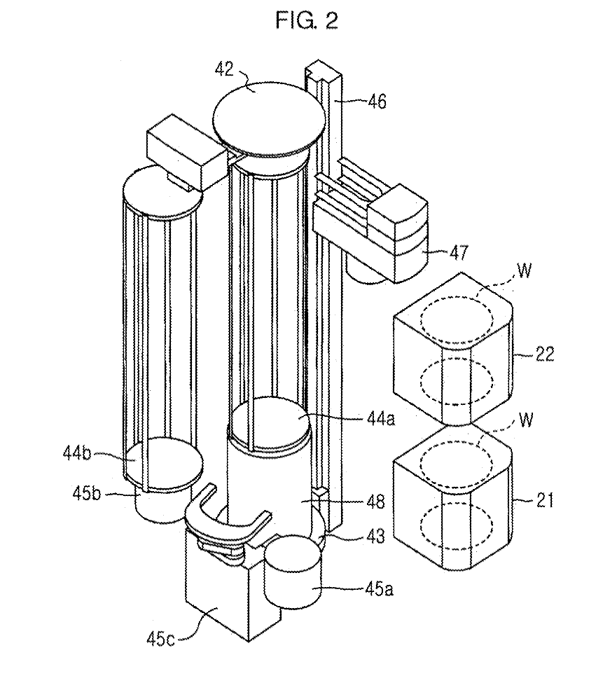

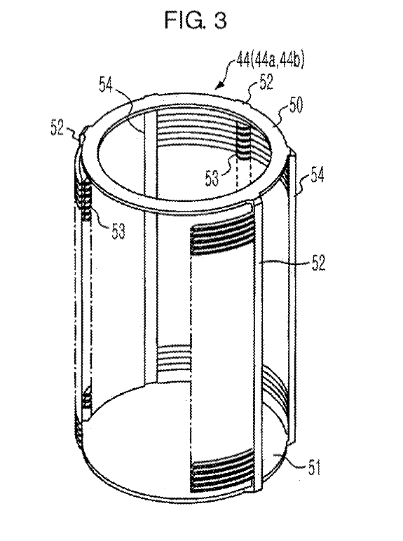

FIG. 1 is a vertical cross-sectional view schematically showing the thermal treatment apparatus 10 of the present embodiment. FIG. 2 is a perspective view schematically showing a loading area 40. FIG. 3 is a perspective view schematically showing an example of a boat 44.

The thermal treatment apparatus 10 includes a holding stage (loading port) 20, a housing 30, and a control unit 100.

The holding stage (loading port) 20 is provided at a front side of the housing 30. The housing 30 includes the loading area (working area) 40 and the thermal treatment furnace 60. The loading area 40 is provided inside the housing 30 at a lower side thereof, and the thermal treatment furnace 60 is provided on and upper side of the loading area 40 inside the housing 30. Also, a base plate 31 is provided between the loading area 40 and the thermal treatment furnace 60.

The holding stage (loading port) 20 is a unit for carrying the wafers W into/out of the housing 30. Accommodating containers 21 and 22 are mounted on the holding stage (loading port) 20. The accommodating containers 21 and 22 are close-type accommodating containers (FOUP) capable of containing the plurality of wafers W, e.g., about 50 wafers W, at predetermined intervals. The accommodating containers 21 and 22 include a detachable cover (not shown) on front surfaces thereof.

Also, an aligner 23 may be provided at a lower side of the holding stage 20 to align cut-out portions (for example, notches) in a direction, provided on outer circumferences of the wafers W transferred by a transfer mechanism 47, to be described below.

In the loading area (working area) 40, the wafers W are transferred between the accommodating containers 21 and 22 and a boat 44 to carry (load) the boat 44 into the processing container 65 and to carry (unload) the boat 44 out of the processing container 65. The loading area 40 includes a door mechanism 41, a shutter mechanism 42, a lid 43, the boat 44, bases 45a and 45b, an elevation mechanism 46. and a transfer mechanism 47.

Also, the lid 43 and the boat 44 correspond to a substrate holding unit in the present invention.

The door mechanism 41 allows the accommodating containers 21 and 22 to communicate with the loading area 40 by detaching the covers of the accommodating containers 21 and 22.

The shutter mechanism 42 is provided at an upper side of the loading area 40. The shutter mechanism 42 is provided to cover (or block) a furnace opening 68a, to be described below, so as to prevent heat inside a high-temperature furnace from being released to the loading area 40 from the furnace opening 68a when the lid 43 is opened.

The lid 43 includes a thermo-container 48 and a rotating mechanism 49. The thermo-container 48 is provided on the lid 43. The thermo-container 48 prevents the boat 44 from being cooled due to heat transfer from the lid 43 and keeps the boat 44 warm. The rotating mechanism 49 is attached to a bottom portion of the lid 43. The rotating mechanism 49 rotates the boat 44. A rotational axis of the rotating mechanism 49 is provided to airtightly penetrate the lid 43 so that a rotational table (not shown) disposed on the lid 43 rotates.

The elevation mechanism 46 elevates the lid 43 when the boat 44 is carried into/out of the processing container 65 from/to the loading area 40. When the lid 43 ascended by the elevation mechanism 46 is carried into the processing container 65, the lid 43 is provided to contact and seal the furnace opening 68a. The boat 44 mounted on the lid 43 may rotatably hold the wafers W inside the processing container 65 within a horizontal plane.

Also, the thermal treatment apparatus 10 may include a plurality of the boats 44. Hereinafter, a case where the thermal treatment apparatus 10 includes two boats 44 will be described with reference to FIG. 2.

A plurality of boats 44a and 44b are provided in the loading area 40. Also, the bases 45a and 45b and a boat transfer mechanism 45c are provided in the loading area 40. The bases 45a and 45b are holding stages where the boats 44a and 44b are transferred from the lid 43, respectively. The boat transfer mechanism 45c transfers the boats 44a and 44b from the lid 43 to the bases 45a and 45b, respectively.

The boats 44a and 44b are formed of, for example, quartz, and are loaded with the wafers W, which are horizontally disposed and each has a diameter, e.g., 300 mm, at predetermined intervals in a vertical direction. In the boats 44a and 44b, a plurality of supporting pillars 52, for example, three supporting pillars 52, are interposed between a top plate 50 and a bottom plate 51, as shown in FIG. 3. Claw units 53 are provided in the supporting pillars 52 to hold the wafers W. Also, the auxiliary pillars 54 may be provided together with the supporting pillars 52.

The transfer mechanism 47 transfers the wafers W between the accommodating containers 21 and 22 and the boats 44a and 44b. The transfer mechanism 47 includes a base 57, an elevating arm 58, and a plurality of forks (transfer plates) 59. The base 57 is provided to be elevated and revolve. The elevating arm 58 is provided to move (to be elevated) using a ball thread in a vertical direction, and the base 57 is provided on the elevating arm 58 to revolve in a horizontal direction.

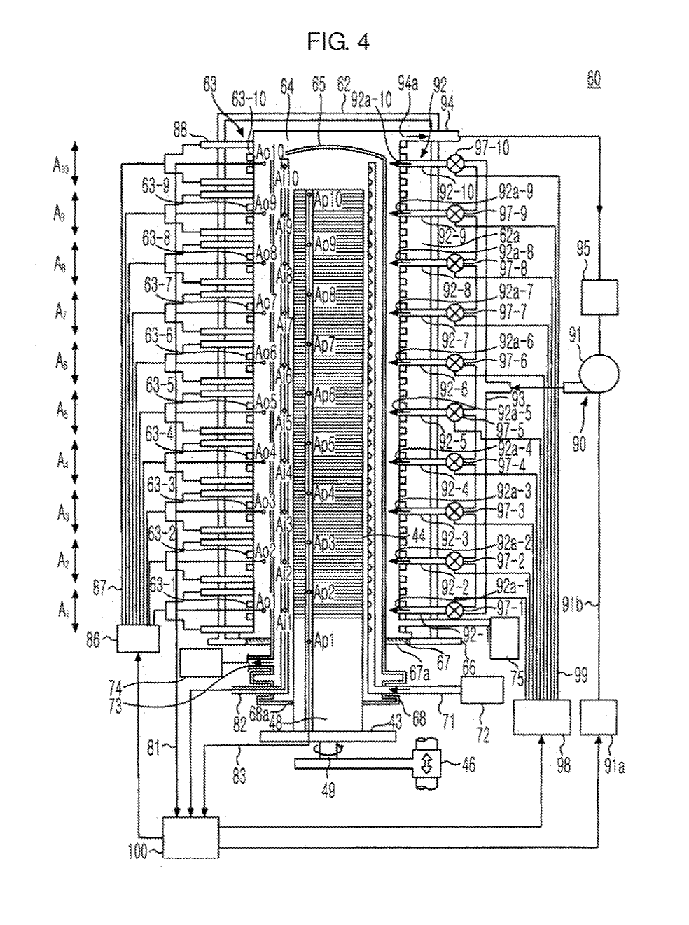

FIG. 4 is a cross-sectional view schematically showing a constitution of the thermal treatment furnace 60.

The thermal treatment furnace 60 may be formed as a vertical furnace for performing a predetermined thermal treatment by accommodating a plurality of substrates to be processed, for example, the wafers W having a thin disc shape.

The thermal treatment furnace 60 includes a jacket 62, a heater 63, a space 64, and the processing container 65.

The processing container 65 accommodates the wafers W held by the boats 44 to perform a thermal treatment. The processing container 65 is formed of, for example, quartz, and has a vertically long shape.

The processing container 65 is supported by a base plate 66 via a manifold 68 provided at a lower portion of the processing container 65. Also, a processing gas is supplied via an injector 71 into the processing container 65 from the manifold 68. The injector 71 is connected to a gas supply source 72. Also, the processing gas or a purge gas supplied into the processing container 65 is connected to an exhaust system 74 including a vacuum pump that may be depressurized through an exhaust port 73.

As described above, the lid 43 blocks the furnace opening 68a provided at a bottom portion of the manifold 68 when the boats 44 are carried into the processing container 65. As described above, the lid 43 is provided to be elevated by the elevation mechanism 46, the thermo-container 48 is mounted on the lid 43, and the boats 44 loaded with the plurality of wafers W at predetermined intervals in a vertical direction are provided on the thermo-container 48.

The jacket 62 is provided to cover around the processing container 65 and defines the space 64 around the processing container 65. Since the processing container 65 has a cylindrical shape, the jacket 62 has a cylindrical shape as well. The jacket 62 is supported by the base plate 66, and an opening 67 for inserting the processing container 65 to an upper portion from a lower portion of the thermal treatment furnace 60 is provided in the base plate 66. An insulator 62a formed of, e.g., glass wool, may be provided outside of the space 64 inside the jacket 62.

Also, the jacket 62 corresponds to a lid unit in the present invention.

In the opening 67 of the present embodiment, an inflow suppressing member 67a may be provided in a gap between the jacket 62 and the processing container 65 to prevent inflow of air into the space 64 from the outside of the jacket 62. The inflow suppressing member 67a may be formed of, e.g., glass wool. Thus, as will be described below, even when pressure inside the space 64 is lower than external pressure (air pressure), external air having a temperature lower than that of gas inside the space 64 may be prevented from entering the space 64 via the opening 67 and thus cause a difference in temperature in a vertical direction.

Also, a differential manometer 75 for measuring differential pressure to air pressure of internal pressure of the space 64 may be provided in the space 64. In order to measure differential pressure to air pressure of internal pressure of the space 64, the differential manometer 75 may be provided to communicate with a portion near the opening 67 inside the space 64.

The heater 63 is provided to cover around the processing container 65 and heats the processing container 65 and the wafers W held by the boats 44, that is, an object to be heated inside the processing container 65. The heater 63 is provided outside of the space 64 inside the jacket 62. The heater 63 is formed of a heating resistor, such as a carbon wire, and thus the heater 63 may control a temperature of gas flowing inside the space 64 and may heat the inside of the processing container 65 to a predetermined temperature of, for example, 50° C. to 1200° C. The heater 63 serves as a heating unit for heating the processing container 65 and the wafers W.

The space 64 and a space inside the processing container 65 are divided into a plurality of unit areas, for example, ten unit areas A1, A2, A3, A4, A5, A6, A7, A8, A9, and A10 in a vertical direction. The heater 63 is also divided into a plurality of heaters 63-1, 63-2, 63-3, 63-4, 63-5, 63-6, 63-7, 63-8, 63-9, and 63-10 to respectively correspond to the unit areas A11, A2, A3, A4, A5, A6, A7, A8, A9, and A10 in a vertical direction. The heaters 63-1 to 63-10 independently control output to the unit areas A1 to A10, respectively, by a heater output unit 86 formed of, e.g., a thyristor. The heaters 63-1 to 63-10 correspond to a heat generating device in the present invention.

Also, in the present embodiment, an example where the space 64 and the space inside the processing container 65 are divided into ten unit areas in a vertical direction has been described. However, the number of unit areas is not limited to ten, and the space 64 may be divided into a number other than ten. Also, in the present embodiment, the space 64 and the space inside the processing container 65 are divided into an equal number. However, the present invention is not limited thereto, and a peripheral portion of the opening 67, where a temperature varies widely, may be divided into smaller areas.

Also, the heaters 63 may be at different locations in a vertical direction. Accordingly, the heaters 63 may be provided not to correspond one-to-one to the unit areas A1 to A10, respectively.

Heater temperature sensors Ao1 to Ao10 for detecting temperatures of the unit areas A1 to 110 are provided in the space 64 to respectively correspond to the unit areas A1 to A10. Also, a plurality of processing container temperature sensors Ai1 to Ai10 for detecting temperatures of the unit areas A1 to A10 are provided in the space inside the processing container 65 to respectively correspond to the unit areas A1 to A10. The heater temperature sensors Ao1 to Ao10 and the processing container temperature sensors Ai1 to Ai10 serve as detectors for detecting temperatures to detect temperature distribution in a vertical direction.

Signals detected by the heater temperature sensors Ao1 to Ao10 and signals detected by the processing container temperature sensors Ai1 to Ai10 are applied to the control unit 100 via a line 81 and a line 82, respectively. The control unit 100 having received the detected signals calculates a setting value for the heater output unit 86 and inputs the calculated setting value to the heater output unit 86. The heater output unit 86 having received the setting value outputs the received setting value to the heaters 63-1 to 63-10 via a heater output line 87 and a heater terminal 88. For example, by calculating the setting value for the heater output unit 86 under PID control, the control unit 100 controls output of the heater output unit 86 to each of the heaters 63-1 to 63-10, that is, heat generated by the heaters 63-1 to 63-10.

Also, the heater temperature sensor Ao and the processing container temperature sensor Ai may be provided at different locations in a vertical direction to detect temperature distribution in a vertical direction inside the processing container 65.

Accordingly, the heater temperature sensor Ao and the processing container temperature sensor Ai may be provided not to respectively correspond one-to-one to the unit areas A1 to A10, respectively.

Also, as shown in FIG. 4, movable temperature sensors Ap1 to Ap10 loaded and unloaded together with the wafers W may be provided, and signals detected by the movable temperature sensors Ap1 to Ap10 may be applied to the control unit 100 via a line 83.

In the present embodiment, the thermal treatment furnace 60 includes a cooling mechanism 90 for cooling the processing container 65.

The cooling mechanism 90 includes a blower 91, a blast pipe 92, a branched portion 93, and an exhaust pipe 94.

The blower 91 sends a cooling gas, including, e.g., air, into the space 64 including the heater 63 to cool the processing container 65.

The blast pipe 92 sends the cooling gas received from the blower 91 to the heater 63. The blast pipe 92 is branched to blast pipes 92-1, 92-2, 92-3, 92-4, 92-5, 92-6, 92-7, 92-8. 92-9, and 92-10 respectively corresponding to the unit areas A1 to A10 via the branched portion 93. A plurality of discharge holes 92a-1 to 92a-10 for discharging the cooling gas to portions respectively corresponding to the unit areas A1 to A10 are provided in the space 64, and the branched blast pipes 92-1 to 92-10 are respectively connected to the discharge holes 92a-1 to 92a-10. In other words, the cooling gas is supplied to the space 64 via the discharge holes 92a-1 to 92a-10, respectively. In the embodiment shown in FIG. 4, each of the blast pipes 92-1 to 92-10 and each of the discharge holes 92a-1 to 92a-10 are provided in a vertical direction.

Also, a discharge hole 92a corresponds to a supply port in the present invention.

The exhaust pipe 94 exhausts air inside the space 64. A vent hole 94a for exhausting the cooling gas from the space 64 is provided in the space 64, and one end of the exhaust pipe 94 is connected to the vent hole 94a.

Also, as shown in FIG. 4, a heat exchanger 95 may be provided in the middle of the exhaust pipe 94, and the other end of the exhaust pipe 94 may be connected to a suction-side of the blower 91. Also, the cooling gas exhausted by the exhaust pipe 94 may be circularly used by being heat-exchanged in the heat exchanger 95 and then being returned to the blower 91 instead of being exhausted to a factory exhaust system. Also, in this case, the cooling gas may be circulated by using an air filter knot shown). Alternatively, the cooling gas exhausted from the space 64 may be exhausted to the factory exhaust system from the exhaust pipe 94 via the heat exchanger 95.

The blower 91 may control air volume of the blower 91 by controlling power supplied from a power supply unit 91 a including, e.g., an inverter, by a signal output from the control unit 100.

When the signals detected by the heater temperature sensors Ao1 to Ao10 and the signals detected by the processing container temperature sensors Ai1 to Ai10 are applied to the control unit 100, the control unit 100 calculates a setting value for the power supply unit 91a and inputs the calculated setting value to the power supply unit 91a. The power supply unit 91a having received the setting value outputs the received setting value to the blower 91 via a blower output line 91b. Thus, the control unit 100 controls air volume of the blower 91.

In the present embodiment, a valve 97, that is, a plurality of valves 97-1 to 97-10 are provided in the blast pipes 92-1 to 92-10, respectively. The valves 97-1 to 97-10 are provided to independently control their opening degrees. The valves 97-1 to 97-10 serve as a flow rate control valve, and the blast pipes 92-1 to 92-10 are provided to independently control their flow rates, respectively. In other words, the blast pipes 92-1 to 92-10 are provided to independently control a flow rate of the cooling gas supplied into the space 64 via the discharge holes 92a-1 to 92a-10, respectively.

The valves 97-1 to 97-10 may be used after adjusting their opening degrees by using, e.g., a manual valve. Alternatively, as shown in FIG. 4, the opening degrees of the valves 97-1 to 97-10 may be controlled by a control signal applied from the valve control unit 98, for example, as in a motor valve.

In the embodiment shown in FIG. 4, the valves 97-1 to 97-10 may be controlled by the valve control unit 98. The control unit 100 having received the signals detected by the heater temperature sensors Ao1 to Ao10 or the signals detected by the processing container temperature sensors Ai1 to Ai10 calculates the setting value for the valve control unit 98 and inputs the calculated setting value to the valve control unit 98. The valve control unit 98 having received the setting value outputs the received setting value to the valves 97-1 to 97-10 via a valve output line 99. Accordingly, the control unit 100 controls the flow rate of the cooling gas supplied via each of the discharge holes 92a-1 to 92a-10 by controlling the opening degrees of the valves 97-1 to 97-10.

Also, the control unit 100 may control the flow rate of the cooling gas supplied via each of the discharge holes 92a-1 to 92a-10 by controlling the air volume of the blower 91 and controlling the opening degrees of the valves 97-1 to 97-10.

Also, the blast pipe 92, the discharge hole 92a, and the valve 97 may be provided at different locations in a vertical direction, respectively. Accordingly, the blast pipe 92, the discharge hole 92a, and the valve 97 may be provided not to correspond one-to-one to the unit areas A1 to A10, respectively.

The control unit 100 includes, for example, an operation processing unit, a memory unit, and a display unit that are not shown in the drawing. The operation processing unit is a computer including, for example, a central processing unit (CPU). The memory unit is a computer-readable storage medium formed of, e.g., a hard disc and having embodied thereon a program for executing various processes. The display unit is formed of, e.g., a computer screen. The operation processing unit performs a thermal treatment, to be described below, by reading a program stored in the memory unit and sending a control signal to components constituting the thermal treatment apparatus 10 according to the program.

Also, a program (sequence) for controlling power supplied to the heater 63 and power to be supplied to the blower 91 is incorporated in the control unit 100 so that temperatures of the wafers W, which are objects to be heated inside the processing container 65, effectively converge on a setting temperature (predetermined temperature). Also, this program may control the power supplied to the heater 63 by the heater output unit 86 and the power supplied to the blower 91 by the power supply unit 91a, and also may control the valve control unit 98 to control an opening degree of the valve 97.

Hereinafter, a thermal treatment method used by the thermal treatment apparatus 10 according to the present embodiment will be described.

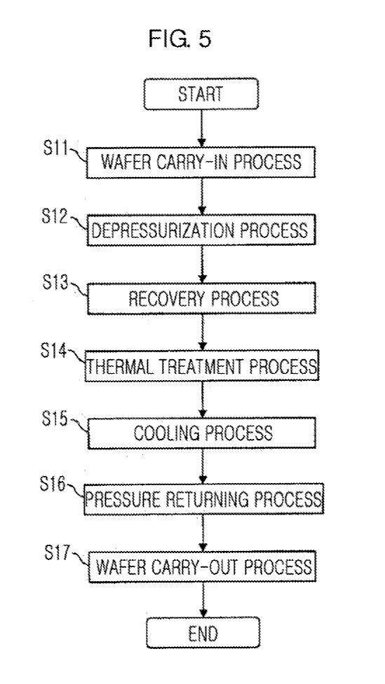

FIG. 5 is a flowchart for describing a sequence of each process of the thermal treatment method using the thermal treatment apparatus 10, according to an embodiment of the present invention.

in the present embodiment, after beginning processes, in step S11, the wafers W are carried into the processing container 65 (wafer carry-in process). In an example of the thermal treatment apparatus 10 shown in FIG. 1, the wafers W may be loaded on the boats 44a from the accommodating container 21 by the transfer mechanism 47 in the loading area 40, and the boats 44a loaded with the wafers W may be mounted on the lid 43 by the boat transfer mechanism 45c. The lid 43 on which the boats 44a are mounted may be elevated by the elevation mechanism 46 to be inserted into the processing container 65, thereby carrying the wafers W into the processing container 65.

Then, in step S12, the inside of the processing container 65 is depressurized (depressurization process). An exhaust volume for exhausting the processing container 65 via the exhaust port 73 may be increased by adjusting an exhaust capability of the exhaust system 74 and a flow rate control valve (not shown) provided between the exhaust system 74 and the exhaust port 73. The inside of the processing container 65 may be depressurized to a predetermined pressure.

Next, in step S13, the temperatures of the wafers W are increased to a predetermined temperature (thermal treatment temperature) during the thermal treatment of the wafers W (recovery process).

Immediately after the boats 44a are carried into the processing container 65, the temperature inside the processing container 65, that is, the temperature of the movable temperature sensors Ap1 to Ap10 is decreased close to room temperature. Thus, the temperatures of the wafers W mounted on the boats 44a are increased to a thermal treatment temperature by supplying power to the heater 63.

In the present embodiment, similarly to step S15 (cooling process) to be described below, the temperatures of the wafers W may be controlled to converge on the thermal treatment temperature by balancing an amount of heating by the heater 63 and an amount of cooling by the cooling mechanism 90.

Next, in step S14, the thermal treatment is performed on the wafers W held by the boat 44 by using the heater 63 (thermal treatment process).

The temperatures of the wafers W are maintained at a predetermined temperature by holding the wafers W with the boats 44 at predetermined intervals in a vertical direction and heating the processing container 65 by using the heater 63. In this state, the processing gas is supplied into the processing container 65 via the injector 71 from the gas supply source 72 to perform a thermal treatment on surfaces of the wafers W. For example, the processing gas, including, e.g., steam, is supplied into the processing container 65 to oxidize the surfaces of the wafers W. Also, the thermal treatment of the wafers W is not limited to oxidation, and various thermal treatments, such as dispersion, depressurized CVD, may be performed on the wafers W.

Next, in step S15, the cooling mechanism 90 cools the processing container 65 by supplying the cooling gas into the space 64 via each of the plurality of discharge holes 92a-1 to 92a-10, thereby decreasing the temperatures of the wafers W from the thermal treatment temperature (cooling process). At this time, the cooling gas supplied by the blower 91 is supplied into the space 64 via the discharge holes 92a of the blast pipes 92 of which the flow rates may be independently controlled, thereby cooling the thermally treated wafers W.

The signals detected by the heater temperature sensors Ao1 to Ao10 and the signals detected by the processing container temperature sensors Ai1 to Ai10 are applied to the control unit 100. The control unit 100 having received the detected signals calculates the setting value for the heater output unit 86, the setting value for the power supply unit 91a, and the setting value for the valve control unit 98, and inputs the calculated setting values to the heater output unit 86, the power supply unit 91a, and the valve control unit 98. The heater output unit 86 having received the setting value outputs the received setting value to the heaters 63-1 to 63-10 via the heater output line 87, respectively. The power supply unit 91a having received the setting value outputs the received setting value to the blower 91 via the blower output line 91b. Also, the valve control unit 98 having received the setting value outputs the received setting value to the valves 97-1 to 97-10 via the valve output line 99.

Also, the detected signals correspond to detected values in the present invention.

In this regard, based on the signals detected by the processing container temperature sensor Ai or the heater temperature sensor Ao, the flow rates of the cooling gases supplied from the discharge holes 92a-1 to 92a-10 may be independently controlled so as to equalize the cooling speed of the processing container 65 in a vertical direction. For example, the flow rates of the cooling gases supplied into the space 64 from each of the discharge holes 92a-1 to 92a-10 may be independently controlled so as to equalize the time rates of change of the temperatures detected by the processing container temperature sensors Ai1 to Ai10 or the heater temperature sensors Ao1 to Ao10, respectively. By controlling the flow rates of the cooling gases, the cooling speeds of the wafers W, that is, the time rates of change of the temperatures of the wafers W, may be equalized. Also, when the temperatures of the wafers W are the same at the time of beginning the cooling process, the time rates of change of the temperatures detected by the processing container temperature sensor Ai or the heater temperature sensor Ao may be equalized to make the temperature of the wafers W uniform during the cooling process.

Also, the time rates of change of the temperatures detected by the processing container temperature sensor Ai or the heater temperature sensor Ao may be equalized by controlling the air volume of the blower 91 and independently controlling the opening degrees of the valves 97-1 to 97-10.

Also, in step S15 (cooling process), based on a cooling curve showing a relationship between a temperature and time previously stored in a program, each of the opening degrees of the valves 97-1 to 97-10 may be independently controlled in real time. Alternatively, before performing step S15 (cooling process) after step S14 (thermal treatment process), each of the opening degrees of the valves 97-1 to 97-10 may be independently controlled, and then the air volume of the blower 91 may be controlled in step S15 (cooling process). Alternatively, before beginning step S11, each of the opening degrees of the valves 97-1 to 97-10 may be independently controlled, and then the air volume of the blower 91 may be controlled in step S15 (cooling process).

Next, in step S16, pressure of the inside of the processing container 65 is returned to air pressure (pressure returning process). An exhaust volume for exhausting the processing container 65 may be decreased by adjusting an exhaust capability of the exhaust system 74 and the flow rate control valve (not shown) provided between the exhaust system 74 and the exhaust port 73. For example, the pressure of the inside of the processing container 65 is returned to air pressure by introducing, e.g., a nitrogen (N₂) purge gas, into the processing container 65.

Next, in step 817, the wafers W are carried out of the processing container 65 (wafer carry-out process). In an example of the thermal treatment apparatus 10 shown in FIG. 1, the lid 43 loaded with the boats 44a may be descended by the elevation mechanism 46 to be carried into the loading area 40 from the processing container 65. The transfer mechanism 47 may transfer the wafers W to the accommodating container 21 from the boats 44a mounted on the lid 43 to carry the wafers W out of the processing container 65, thereby completing the thermal treatment.

Also, when a thermal treatment is continuously performed on a plurality of batches, the wafers W are transferred to the boats 44 from the accommodating container 21 by the transfer mechanism 47 in the loading area 40, and then the process returns to step S11 to perform a thermal treatment on the next batch.

### An Embodiment

In the present embodiment, the boats 44 holding the wafers W are actually carried into the processing container 65, temperatures of each of the unit areas during step S15 (cooling process) are measured, and a difference in temperature between the unit areas is evaluated. A result of the evaluation will be described below.

As the present embodiment, when the opening degree of the valve 97-1 closest to the opening 67 is previously set to 50% and the opening degrees of the remaining valves 97-2 to 97-10 are previously set to 100%, the cooling process is performed in such a way that the temperature is decreased from 800° C. to 400° C. as an example of step S15 (cooling process). Also, as a comparative example 1, when the opening degrees of all the valves 97-1 to 97-10 are previously set to 100%, the cooling process is performed in such a way that the temperature is decreased from 800° C. to 400° C., similar to the present embodiment. Also, in the present embodiment and the comparative example 1, differential pressure to air pressure of the space 64 measured by the differential manometer 75 is about 0 Pa, and internal pressure of the space 64 is nearly the same as air pressure.

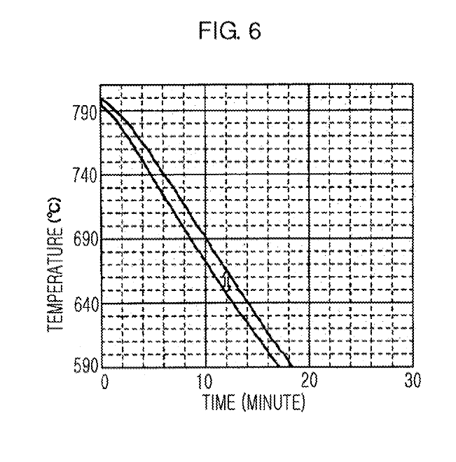

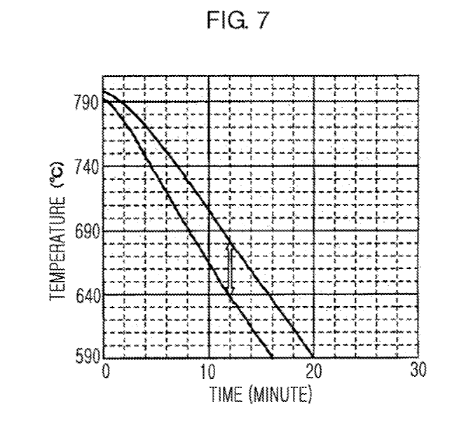

FIGS. 6 and 7 are graphs showing a relationship between a temperature and time in each unit area, according to the present embodiment and the comparative example 1, respectively. In order to facilitate the illustration, FIGS. 6 and 7 only show a detected highest temperature and a detected lowest temperature from among temperatures detected by the processing container temperature sensors Ai1 to Ai10.

Table 1 shows a time rate of change of temperature (hereinafter, referred to as “cooling speed”) and a difference (hereinafter, referred to as “difference in surface temperature”) between the detected highest temperature and the detected lowest temperature at 12 minutes after beginning the cooling process in the present embodiment and the comparative example 1.

TABLE 1

| | Present | Comparative | Comparative |
|---|---|---|---|
| | Embodiment | Example 1 | Example 2 |
| Cooling speed (°C./min) | 9.8 | 9.3 | 9.4 |
| Difference in surface | 18.3 | 43.3 | 92.3 |
| temperature (°C.) | | | |

As shown in Table 1, in the present embodiment and the comparative example 1, the cooling speed is nearly the same. Also, the difference in surface temperature at 12 minutes after beginning the cooling process in the present embodiment is 18.3° C., which is lower than a maximum difference in surface temperature 43.3° C. at the same time in the comparative example 1. Thus, according to the present embodiment, the cooling speed in a vertical direction may be prevented from varying.

Even when the cooling speed varies as in the comparative example 1, the cooling speed in each of the unit areas may be controlled to be equalized by increasing a difference in output of the heater 63 in each of the unit areas. However, for this, there is a need to make the output of the heater 63 in the unit area having a great cooling speed exceed the output of the heater 63 in other unit areas. Accordingly, the entire power consumption may be increased.

On the other hand, in the present embodiment, the opening degree of the valve 97 in each unit area is independently controlled, and the flow rate of the cooling gas supplied via the discharge hole 92a in each unit area is independently controlled. Thus, even though the difference in output of the heater 63 between the unit areas is not increased, the cooling speed of each of the unit areas may be controlled to be equalized.

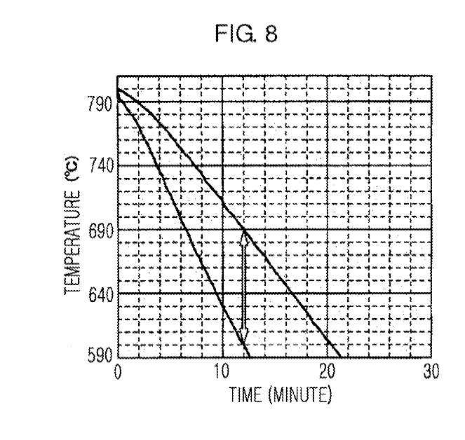

Also, as the comparative example 2, when the inflow suppressing member 67a is removed and when differential pressure of the space 64 measured by the differential manometer 75 to air pressure is −11 Pa, the cooling process is performed in such a way that the temperature is decreased from 800° C. to 400° C., similar to the comparative example 1. FIG. 8 is a graph showing a relationship between temperature and time in each unit area, according to the comparative example 2. In order to facilitate the illustration. FIG. 8 shows only a detected highest temperature and a detected lowest temperature from among temperatures detected by the processing container temperature sensors Ai1 to Ai10. Also, Table 1 shows the cooling speed and the difference in surface temperature in the comparative example 2.

As shown in Table 1, in the comparative example 2, the cooling speed is nearly the same. Also, the difference in surface temperature at 12 minutes after beginning the cooling process in the comparative example 2 is 92.3° C., which is higher than the difference in surface temperature 43.3° C. at the same time point in the comparative example 1. Thus, if the differential pressure of internal pressure of the space 64 to air pressure becomes negative pressure, the difference in surface temperature is increased, due to the fact that the cooling speed around the opening 67 is increased because external air close to room temperature flows into the space 64 maintained at negative pressure from the opening 67.

### Another Embodiment

In the present embodiment, the effects of providing the inflow suppressing member 67a are evaluated, and a result of the evaluation will be described below.

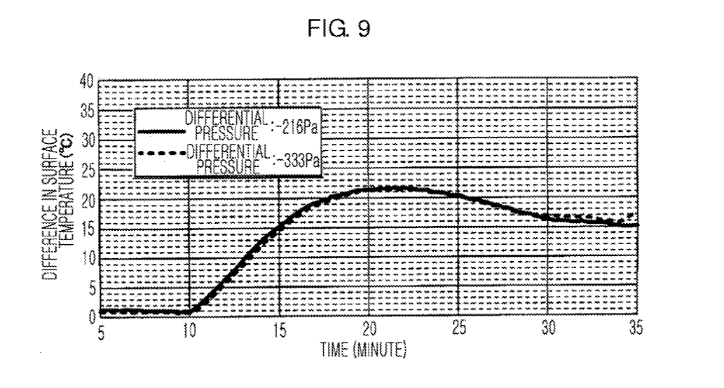

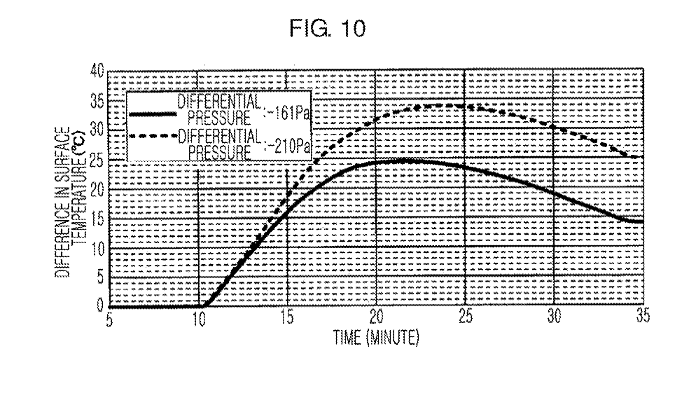

FIGS. 9 and 10 are graphs for describing the effects of the inflow suppressing member 67a. The graphs of FIGS. 9 and 10 show a relationship between a difference (hereinafter, referred to as “difference in surface temperature”) between a detected highest temperature and a detected lowest temperature from among temperatures detected by the processing container temperature sensors Ai1 to Ai10 and time.

In FIG. 9, the inflow suppressing member 67a is provided and when the differential pressure of the space 64 to air pressure is −216 Pa or −333 Pa, the cooling process is performed in such a way that the temperature is decreased from 570° C. to 300° C. (step S15).

On the other hand, in FIG. 10, the inflow suppressing member 67a is not provided and when the differential pressure of the space 64 to air pressure is −161 Pa or −210 Pa, the cooling process is performed in such a way that the temperature is decreased from 570° C. to 300° C. (step S15).

Under the condition shown in FIG. 9, the inflow suppressing member 67a is provided in the gap between the jacket 62 and the processing container 65 in the opening 67. Thus, even when the internal pressure of the space 64 changes, the difference in surface temperature at time points varies slightly. On the other hand, under the condition shown in FIG. 10, the inflow suppressing member 67a is not provided in the gap between the jacket 62 and the processing container 65 in the opening 67. Thus, when the internal pressure of the space 64 changes, the difference in surface temperature at time points varies significantly.

In general, when the internal pressure of the space 64 changes, as an absolute value of negative differential pressure of the space 64 to air pressure is increased, an amount of external air flowing into the space 64 from the opening 67 is increased, and thus, the difference in surface temperature is increased as shown in FIG. 10. However, even when the internal pressure of the space 64 is negative pressure to air pressure, the external air close to room temperature may be effectively prevented from flowing into the space 64 from the opening 67 by providing the inflow suppressing member 67a in FIG. 9.

Accordingly, the cooling speed of each of the unit areas may be easily controlled to be equal by providing the inflow suppressing member 67a in the thermal treatment apparatus 10 in which flow rates of gas supplied by a supply unit via each of the supply ports in the present invention may be independently controlled.

### Another Embodiment

Also, as a thermal treatment method of the present embodiment, in the cooling process, the processing container temperature sensor Ai may control the heater temperature sensor Ac to be a predetermined temperature pattern, and a plurality of modes of setting the temperature pattern may be established. Hereinafter, an example where the thermal treatment method includes a first mode capable of controlling temperature uniformity between the wafers W at a high precision and a second mode capable of reducing power consumption, even though an accuracy of temperature uniformity between the wafers W is slightly decreased, will be described.

In the first mode, the opening degrees of the valves 97-1 to 97-10 are independently controlled, the air volume of the blower 91 is controlled, and the amounts of heat generated by the heaters 63-1 to 63-10 are independently controlled. Also, all temperatures detected by the processing container temperature sensors Ai1 to Ai10 or the heater temperature sensors Ao1 to Ao10 are controlled in the same temperature pattern that is previously set.

In the second mode, when heating by the heaters 63-1 to 63-10 is stopped, the opening degrees of the valves 97-1 to 97-10 are independently controlled and the air volume of the blower 91 is controlled. Also, all temperatures detected by the processing container temperature sensors Ai1 to Ai10 or the heater temperature sensors Ao1 to Ao10 are controlled in the same temperature pattern that is previously set.

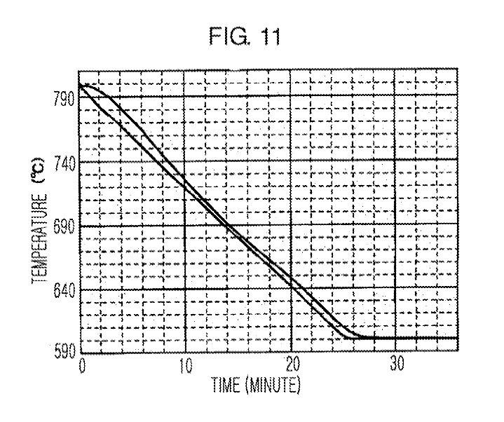

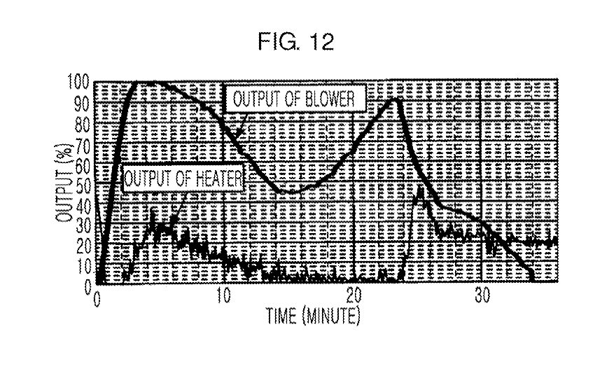

FIG. 11 is a graph showing a relationship between temperatures detected by the processing container temperature sensors Ai1 to Ai10 and time when the first mode is performed. FIG. 12 is a graph showing a relationship between outputs of the blower 91 and the heater 63 and time when a result of FIG. 11 is obtained. Also. FIG. 11 shows an example where the temperature is decreased from 800° C. to 600° C. Also, in order to facilitate the illustration, FIG. 12 shows only output of any one of the heaters 63-1 to 63-10 as the output of heaters 63.

Also, Table 2 shows a difference in surface temperature between a detected highest temperature and a detected lowest temperature at 12 minutes after beginning the cooling process and accumulated power during the cooling process to the first mode and the second mode.

TABLE 2

| | First Mode | Second Mode |
|---|---|---|
| Difference in surface temperature (°C.) | 7.5 | 27.4 |
| Power consumption during cooling | 3.64 | 1.63 |
| process (kWh) | | |

As shown in FIG. 12, the output of the blower 91 is 100% at about 800° C. immediately after beginning the cooling process, the output of the blower 91 is decreased to about 45%, and then the output of the blower 91 is gradually increased with a decrease in temperature. The output of the blower 91 is increased at about 600° C. just before the end of the cooling process, and then the output of the blower 91 becomes 0% after the end of the cooling process.

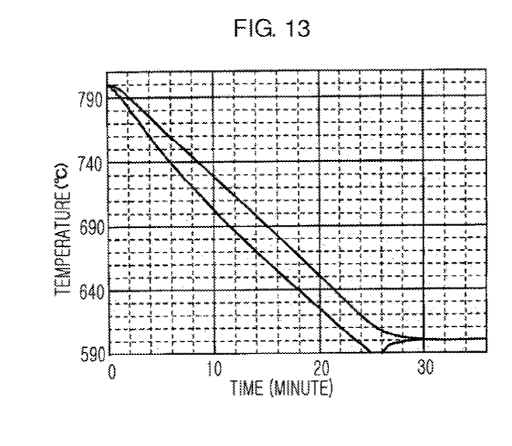

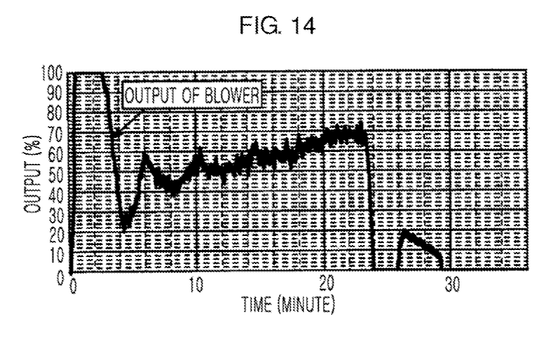

FIG. 13 is a graph showing a relationship between temperatures detected by the processing container temperature sensors Ai1 to Ai10 and time when the second mode is performed. FIG. 14 is a graph showing a relationship between outputs of the blower 91 and the heater 63 and time when a result of FIG. 13 is obtained. Also, FIG. 13 shows an example where the temperature is decreased from 800° C. to 600° C.

As shown in FIG. 14, the output of the blower 91 is 100% at about 800° C. immediately after beginning the cooling process, the output of the blower 91 is decreased to about 20%, and then the output of the blower 91 is gradually increased with a decrease in temperature. The output of the blower 91 is increased at about 600° C. just before the end of the cooling process, and then the output of the blower 91 becomes 0% after the end of the cooling process.

In the second mode, as shown in FIG. 13, since the cooling speed is increased in the unit areas close to the opening 67, the difference in surface temperature is slightly increased. However, as shown in FIG. 14, since there is no output of the heater 63, power consumption may be reduced.

As shown in Table 2, the difference in surface temperature in the second mode is 27.4° C., which is slightly higher than the difference in surface temperature 7.5° C. of the first mode. However, the power consumption during the cooling process of the second mode is 1.63 kWh, which is lower than the power consumption 3.64 kWh during the cooling process of the first mode.

Also, a third mode, which is an intermediate mode between the first mode and the second mode, may be established. The third mode may be obtained by multiplying the output of the heater 63 in the first mode by a predetermined ratio. Thus, power consumption in the third mode may be reduced compared to that in the first mode without decreasing temperature uniformity between the wafers W.

While this invention has been particularly shown and described with reference to exemplary embodiments thereof, it will be understood by those skilled in the art that various changes in form and details may be made therein without departing from the spirit and scope of the invention as defined by the appended claims.

Also, the above-described embodiments have described an example where a plurality of heaters, a plurality of discharge holes, and a plurality of temperature sensors that extend in a direction are provided inside a processing container included in a thermal treatment apparatus for performing a thermal treatment on a substrate. However, the heaters, the discharge holes, and the temperature sensors may be provided in a temperature control system for controlling a temperature of a container extending in a direction. Also, in the temperature control system, when cooling the container, a temperature control method for independently controlling flow rates of cooling gases supplied via the discharge holes may be performed to equalize a cooling speed of the container in the direction based on values detected by the temperature sensors.

According to the present invention, when a container extending in a certain direction is cooled, a cooling speed of the container can be prevented from varying along a direction in which the container extends without increasing power consumption.

What is claimed is:

1. A thermal treatment apparatus for performing a thermal treatment on a substrate, the thermal treatment apparatus comprising:
a processing container;
a substrate holding unit which holds a plurality of substrates at predetermined intervals in a direction inside the processing container;
a heating unit which heats the processing container; and
a cooling unit which comprises a supply unit for supplying gas and a plurality of supply ports provided respectively at different locations in the direction, and cools the processing container as the supply unit supplies the gas into the processing container via each of the supply ports,
wherein the cooling unit is provided in such a way that the supply unit independently controls flow rates of the gases supplied via each of the supply ports.

2. The thermal treatment apparatus of claim 1, wherein the cooling unit is provided to independently control the flow rates of the gases so that a cooling speed of the processing container is equalized in the direction when cooling the processing container.

3. The thermal treatment apparatus of claim 2, further comprising:
a detecting unit which comprises a plurality of detection devices provided respectively at different locations in the direction and detects temperature distribution in the direction inside the processing container; and
a control unit which independently controls the flow rates of the gases so as to equalize the cooling speed of the processing container in the direction based on the values detected by the detecting unit, when cooling the processing container.

4. The thermal treatment apparatus of claim 3, wherein the heating unit comprises a plurality of heat generating devices provided respectively at different locations in the direction, and
the control unit independently controls the amounts of heat generated by each of the heat generating devices and independently controls the flow rates of the gases so as to equalize the cooling speed of the processing container in the direction based on the values detected by the detecting unit, when cooling the processing container.

5. The thermal treatment apparatus of claim 3, wherein the supply unit is a blower for sending gas,
the cooling unit comprises a plurality of flow rate control valves respectively provided at flow paths via which gases supplied to each of the supply ports from the blower flow, and
the control unit independently controls the flow rates of the gases by controlling air volume of gas sent by the blower and independently controlling each of opening degrees of the flow rate control valves so as to equalize the cooling speed of the processing container in the direction based on the values detected by the detecting unit, when cooling the processing container.

6. The thermal treatment apparatus of claim 1, further comprising a lid unit which is provided to cover around the processing container and defines a space around the processing container, the inside of the space being evacuated via a vent hole,
wherein the cooling unit cools the processing container by supplying gas via each of the supply ports into the space that is evacuated via the vent hole,
the lid unit comprises an opening therein, and the processing container is inserted into the lid unit via the opening, and
an inflow suppressing member is provided in a gap between the lid unit and the processing container in the opening to prevent external air from flowing into the lid unit via the gap.

7. A temperature control system for controlling a temperature of a container extending in a direction, the temperature control system comprising:
a heating unit which heats the container;
a cooling unit which comprises a supply unit for supplying gas and a plurality of supply ports provided respectively at different locations in the direction, and cools the container as the supply unit supplies the gas into the container via each of the supply ports;
a detecting unit which comprises a plurality of detection devices provided respectively at different locations in the direction and detects a temperature distribution in the direction inside the container; and
a control unit which independently controls flow rates of gases supplied by the supply unit via each of the supply ports so as to equalize a cooling speed of the container in the direction based on values detected by the detecting unit, when cooling the container.

8. The temperature control system of claim 7, wherein the heating unit comprises a plurality of heat generating devices provided respectively at different locations in the direction, and the control unit independently controls the amounts of heat generated by the heat generating devices and the flow rates of the gases so as to equalize the cooling speed of the container in the direction based on the values detected by the detecting unit, when cooling the container.

9. The temperature control system of claim 7, wherein the supply unit is a blower for sending gas,
the cooling unit comprises a plurality of flow rate control valves respectively provided at flow paths via which gases supplied to each of the supply ports from the blower flow, and
the control unit independently controls the flow rates of the gases by controlling air volume of gas sent by the blower and independently controlling each of opening degrees of the flow rate control valves so as to equalize the cooling speed of the container in the direction based on the values detected by the detecting unit, when cooling the container.

10. A thermal treatment method used to perform a thermal treatment on a substrate, the method comprising:
when a plurality of substrates are held by a substrate holding unit at predetermined intervals in a direction inside a processing container, performing a thermal treatment on the plurality of substrates held by the substrate holding unit by heating the processing container by a heating unit; and
after the performing of the thermal treatment, cooling the processing container by supplying gas into the processing container by a supply unit via each of a plurality of supply ports provided respectively at different locations in the direction;
wherein the cooling of the processing container comprises independently controlling flow rates of gases supplied by the supply unit via each of the supply ports so as to equalize a cooling speed of the processing container in the direction.

11. The thermal treatment method of claim 10, wherein the cooling of the processing container comprises independently controlling the flow rates so as to equalize the cooling speed of the processing container in the direction based on values detected by a detecting unit that comprises a plurality of detecting devices provided respectively at different locations in the direction and detects a temperature distribution in the direction inside the processing container.

12. The thermal treatment method of claim 11, wherein the heating unit comprises a plurality of heat generating devices provided respectively at different locations in the direction, and the cooling of the processing container comprises independently controlling the amounts of heat generated by the heat generating devices and independently controlling the flow rates of the gases so as to equalize the cooling speed of the processing container in the direction based on the values detected by the detecting unit.

13. The thermal treatment method of claim 11, wherein the supply unit is a blower for sending gas, and the cooling of the processing container comprises independently controlling the flow rates of the gases by controlling air volume of gas sent by the blower and independently controlling a plurality of flow rate control valves respectively provided at flow paths via which gases supplied to each of the supply ports from the blower flow so as to equalize the cooling speed of the processing container in the direction based on the values detected by the detecting unit.

14. A temperature control method used to control a temperature of a container extending in a direction, the method comprising:
heating the container by a heating unit; and
cooling the container by supplying gas into the container by a supply unit via each of a plurality of supply ports provided respectively at different locations in the direction;
wherein the cooling of the container comprises independently controlling flow rates of gases supplied by the supply unit via each of the supply ports so as to equalize a cooling speed of the container in the direction.

15. The temperature control method of claim 14, wherein the cooling of the container comprises independently controlling the flow rates so as to equalize the cooling speed of the container in the direction based on values detected by a detecting unit that comprises a plurality of detecting devices provided respectively at different locations in the direction and detects a temperature distribution in the direction inside the container.

16. The temperature control method of claim 15, wherein the heating unit comprises a plurality of heat generating devices provided respectively at different locations in the direction, and the cooling of the container comprises independently controlling the amounts of heat generated by the heat generating devices and independently controlling the flow rates of the gases so as to equalize the cooling speed of the container in the direction based on the values detected by the detecting unit.

17. The temperature control method of claim 15, wherein the supply unit is a blower for sending gas, and the cooling of the container comprises independently controlling the flow rates of the gases by controlling air volume of gas sent by the blower and independently controlling a plurality of flow rate control valves respectively provided at flow paths via which gases supplied to each of the supply ports from the blower flow so as to equalize the cooling speed of the container in the direction based on the values detected by the detecting unit.

18. A non-transitory computer readable medium embodied with a program for executing the thermal treatment method of claim 10.

19. A non-transitory computer readable medium embodied with a program or executing the temperature control method of claim 14.
